(19) United States
(12) Patent Application Publication
(10) Pub. No.: US 2019/0190012 A1
(43) Pub. Date: Jun. 20, 2019

(54) HYBRID NEGATIVE ELECTRODES FOR FAST CHARGING AND HIGH-ENERGY LITHIUM BATTERIES

(71) Applicant: GM GLOBAL TECHNOLOGY OPERATIONS LLC, Detroit, MI (US)

(72) Inventors: Yan Wu, Troy, MI (US); Meng Jiang, Rochester Hills, MI (US); Mark W. Verbrugge, Troy, MI (US); Raghunathan K, Troy, MI (US)

(73) Assignee: GM GLOBAL TECHNOLOGY OPERATIONS LLC, Detroit, MI (US)

(21) Appl. No.: 15/843,942

(22) Filed: Dec. 15, 2017

(51) Int. Cl. H01M 4/36; H01M 10/0525; H01M 4/485; H01M 4/587; H01M 4/133; H01M 4/131; H02J 7/00; H02P 27/08

(52) U.S. Cl. CPC H01M 4/364; H01M 4/366; H01M 10/0525; H01M 4/485; H01M 2004/027; H01M 4/133; H01M 4/131; H02J 7/0068; H02P 27/08; H01M 4/587

(57) ABSTRACT

A hybrid negative electrode having high energy capacity and high power capacity used in an electrochemical cell for lithium-ion electrochemical batteries is provided. The electrode may include about 40% to about 60% by mass of a high energy capacity electroactive material having a specific capacity of greater than or equal to about 310 mAh/g and about 40% to about 60% by mass of a high power capacity electroactive material having a potential versus Li/Li+ of greater than or equal to about 1 V during lithium ion insertion. The hybrid negative electrode is capable of a charge rate of greater than or equal to about 4 C at 25° C. In other variations, an electrochemical cell is provided that includes a first negative electrode with a high energy capacity electroactive material and a second negative electrode with a high power capacity electroactive material.

### INTRODUCTION

This section provides background information related to the present disclosure which is not necessarily prior art.

The present disclosure relates to hybrid negative electrodes having high energy capacity and high power capacity for lithium-ion electrochemical cells. The hybrid negative electrode may include a high energy capacity electroactive material and a high power capacity electroactive material. An electrochemical cell for lithium-ion electrochemical devices is also provided that includes a first negative electrode with a high energy capacity electroactive material and a second negative electrode with a high power capacity electroactive material.

High-energy density, electrochemical cells, such as lithium-ion batteries can be used in a variety of consumer products and vehicles, such as hybrid or electric vehicles. Typical lithium-ion batteries comprise a first electrode, such as a positive electrode or cathode, a second electrode such as a negative electrode or an anode, an electrolyte material, and a separator. Often a stack of lithium-ion battery cells are electrically connected in an electrochemical device to increase overall output. Lithium-ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery. Each of the negative and positive electrodes within a stack is connected to a current collector (typically a metal, such as copper for the anode and aluminum for the cathode). During battery usage, the current collectors associated with the two electrodes are connected by an external circuit that allows current generated by electrons to pass between the electrodes to compensate for transport of lithium ions.

The negative electrode may include a lithium insertion material or an alloy host material. For hybrid and electric vehicles, the most common electroactive material for forming a negative electrode/anode is graphite that serves as a lithium-graphite intercalation compound. Graphite is the commonly used negative electrode material because of its desirably high specific capacity (approximately 350 mAh/g).

However, when using graphite as a negative electrode in a lithium-ion battery, lithium plating can occur during fast charging of lithium ion batteries, for example, when the potential at the negative electrode is close to 0 V versus a lithium metal reference (a potential versus Li/Li+). Lithium plating can cause loss of performance in the negative electrode and is believed to occur when lithium ions deposit as metallic lithium on a surface of the electrode, rather than intercalating into the electroactive material within the electrode. This phenomenon can occur with graphite negative electrodes under various conditions, including fast charging processes noted above (where graphite operates at a lower potential and hence can experience voltages near 0 V) or during cold temperature charging. It would be desirable to have a negative electrode that can exhibit both high energy/high specific capacity and as well as high power/fast charging capacity, especially for plug-in hybrid and electric vehicle applications where rapid charging at charging stations may be desirable.

### SUMMARY

This section provides a general summary of the disclosure, and is not a comprehensive disclosure of its full scope or all of its features.

In various aspects, the present disclosure provides a hybrid negative electrode having high energy capacity and high power capacity. The hybrid negative electrode includes a hybrid electroactive material including greater than or equal to about 40% by mass to less than or equal to about 60% by mass of a high energy capacity electroactive material having a specific capacity of greater than or equal to about 310 mAh/g and greater than or equal to about 40% by mass to less than or equal to about 60% by mass of a high power capacity electroactive material having a potential versus Li/Li+ of greater than or equal to about 1 V during lithium ion insertion. The hybrid negative electrode is capable of a charge rate of greater than or equal to about 4 C at 25° C.

In one aspect, the high energy capacity electroactive material is selected from the group consisting of: carbon-containing compounds, graphite, silicon, silicon-containing alloys, tin-containing alloys, and combinations thereof.

In one aspect, the high power capacity electroactive material is a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof.

In one aspect, the high energy capacity electroactive material includes graphite and the high power capacity electroactive material includes Li₄₊ₓTi₅O₁₂, where 0≤x≤3.

In one aspect, the high energy capacity electroactive material is disposed as a coating on a surface of a particle of the high power capacity electroactive material.

In one aspect, the high power capacity electroactive material is disposed as a coating on a surface of a particle of the high energy capacity electroactive material.

In one aspect, the hybrid negative electrode further includes a binder and an electrically conductive particle. The hybrid electroactive material and electrically conductive particle are distributed within the binder. The binder is selected from the group consisting of: polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, and combinations thereof. The electrically conductive particle includes a material selected from the group consisting of: carbon black, conductive metal, conductive polymer, and combinations thereof.

In various aspects, the present disclosure further contemplates a hybrid negative electrode including a current collector, a first layer disposed on the current collector including a high power capacity electroactive material having a specific capacity of greater than or equal to about 310 mAh/g, a first binder, and a first electrically conductive particle. The high power capacity electroactive material and the first electrically conductive particle are distributed in the first binder. The hybrid negative electrode also includes a second layer disposed on the first layer including a high energy capacity electroactive material having a potential versus Li/Li+ of greater than or equal to about 1 V during lithium ion insertion, a second binder, and a second electrically conductive particle. The high energy capacity electroactive material and the second electrically conductive particle are distributed in the second binder. The hybrid negative electrode is capable of a charge rate of greater than or equal to about 4 C at 25° C.

In one aspect, the high energy capacity electroactive material is selected from the group consisting of: carbon-containing compounds, graphite, silicon, silicon-containing alloys, tin-containing alloys, and combinations thereof and the high power capacity electroactive material is a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤X^{b}≤1, Li₄₋ₓ^{c}Znₓ^{c}Ti₅O₁₂, where 0≤x^{c}≤1, Li₄TiNb₂O₇, and combinations thereof.

In one aspect, the high energy capacity electroactive material includes graphite and the high power capacity electroactive material includes Li₄₊ₓTi₅O₁₂, where 0≤x≤3.

In one aspect, the first layer has a thickness of greater than or equal to about 10 micrometers to less than or equal to about 300 micrometers and the second layer has a thickness of greater than or equal to about 10 micrometers to less than or equal to about 300 micrometers.

In one aspect, the first layer includes greater than or equal to about 80 to less than or equal to about 100% by mass of the high power capacity electroactive material, greater than or equal to about 0 to less than or equal to about 10% by mass of the first binder, and greater than or equal to about 0 to less than or equal to about 10% by mass of the first electrically conductive particle. The second layer includes greater than or equal to about 80 to less than or equal to about 100% by mass of the high energy capacity electroactive material, greater than or equal to about 0 to less than or equal to about 10% by mass of the second binder, and greater than or equal to about 0 to less than or equal to about 10% by mass of the second electrically conductive particle.

In one aspect, the first binder and the second binder are independently selected from the group consisting of: polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, and combinations thereof. The first electrically conductive particle and the second electrically conductive particle independently include a material selected from the group consisting of: carbon black, conductive metal, conductive polymer, and combinations thereof.

In various aspects, the present disclosure further provides an electrochemical cell for a lithium-ion electrochemical battery including a first positive electrode including a positive electroactive material, a first negative electrode including a first negative current collector including a high power capacity electroactive material having a potential versus Li/Li+ of greater than or equal to about 1 V during lithium ion insertion, and a first separator disposed between the first positive electrode and the first negative electrode. The electrochemical cell further includes a second positive electrode including a positive electroactive material, a second negative electrode including a second negative current collector including a high energy capacity electroactive material having a specific capacity of greater than or equal to about 310 mAh/g, a second separator disposed between the second positive electrode and the second negative electrode, and at least one positive current collector in electrical communication with the first positive electrode, the second positive electrode, or both the first positive electrode and the second positive electrode. The first negative current collector is in electrical communication with the at least one positive current collector via a first circuit having a first switch component and the second negative current collector is in electrical communication with the at least one positive current collector via a second circuit having a second switch component. The first circuit and the second circuit are configured to be selectively connected to a charging device or a load device and the first negative electrode, the second negative electrode, or both the first negative electrode and the second negative electrode can be selectively activated by activation of the first switch component and/or the second switch component.

In one aspect, the charging device includes an AC power source and the load device includes an electric motor.

In one aspect, the load device further includes a three-phase power inverter power module with drive gates and a capacitive input filter.

In one aspect, the high power capacity electroactive material in the first negative electrode is a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof.

In one aspect, the high energy capacity electroactive material in the second negative electrode is selected from the group consisting of: carbon-containing compounds, graphite, silicon, silicon-containing alloys, tin-containing alloys, and combinations thereof.

In one aspect, the high power capacity electroactive material in the first negative electrode includes Li₄₊ₓTi₅O₁₂, where 0≤x≤3 and the high energy capacity electroactive material in the second negative electrode includes graphite.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell including a negative electrode.

FIG. 2 is a sectional view of one variation of a hybrid negative electrode prepared in accordance with certain aspects of the present disclosure including two distinct electroactive materials combined together in an electroactive layer.

FIG. 3 shows a sectional view of another variation of a hybrid negative electrode prepared in accordance with certain aspects of the present disclosure including two distinct electroactive materials, where one electroactive material is coated onto a particle of a second distinct electroactive material.

FIG. 4 shows a sectional view of yet another variation of a hybrid negative electrode prepared in accordance with certain aspects of the present disclosure including multiple distinct electroactive material layers.

FIG. 5 shows a sectional side view of an electrochemical cell incorporating a hybrid negative electrode design according to certain aspects of the present disclosure, where a first negative electrode includes a first electroactive material and a second negative electrode includes a second electrode including a second distinct electroactive material.

FIG. 6 shows an energy storage device stack including a plurality of representative electrochemical cells like that shown in FIG. 5, where the stack is connected to an external charging device and therefore in a charging state.

FIG. 7 shows an energy storage device stack including a plurality of representative electrochemical cells like that shown in FIGS. 5-6, where the stack is connected to an exemplary load device, including an inverter power module and an electric motor.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges. Unless otherwise specified, percentages are provided in mass/weight %.

Example embodiments will now be described more fully with reference to the accompanying drawings.

The present technology pertains to improved electrochemical cells that may be incorporated into energy storage devices like lithium-ion batteries, which may be used in vehicle applications. However, the present technology may also be used in other electrochemical devices, especially those that cycle lithium ions. A hybrid negative electrode having both high energy capacity and high power capacity is provided that can be incorporated into such an electrochemical cell that cycles lithium ions, like a lithium-ion battery. In certain aspects, the hybrid negative electrode may comprise a hybrid electroactive material comprising greater than or equal to about 20% by mass to less than or equal to about 80% by mass of a high energy capacity electroactive material and greater than or equal to about 20% by mass to less than or equal to about 80% by mass of a high power capacity electroactive material, as will be discussed in greater detail below. In certain other aspects, the hybrid negative electrode comprises a hybrid electroactive material comprising greater than or equal to about 40% by mass to less than or equal to about 60% by mass of a high energy capacity electroactive material and greater than or equal to about 40% by mass to less than or equal to about 60% by mass of a high power capacity electroactive material. In one aspect, the hybrid negative electrode may comprise a hybrid electroactive material comprising greater than or equal to about 45% by mass to less than or equal to about 55% by mass of a high energy capacity electroactive material and greater than or equal to about 45% by mass to less than or equal to about 55% by mass of a high power capacity electroactive material, as will be discussed in greater detail below.

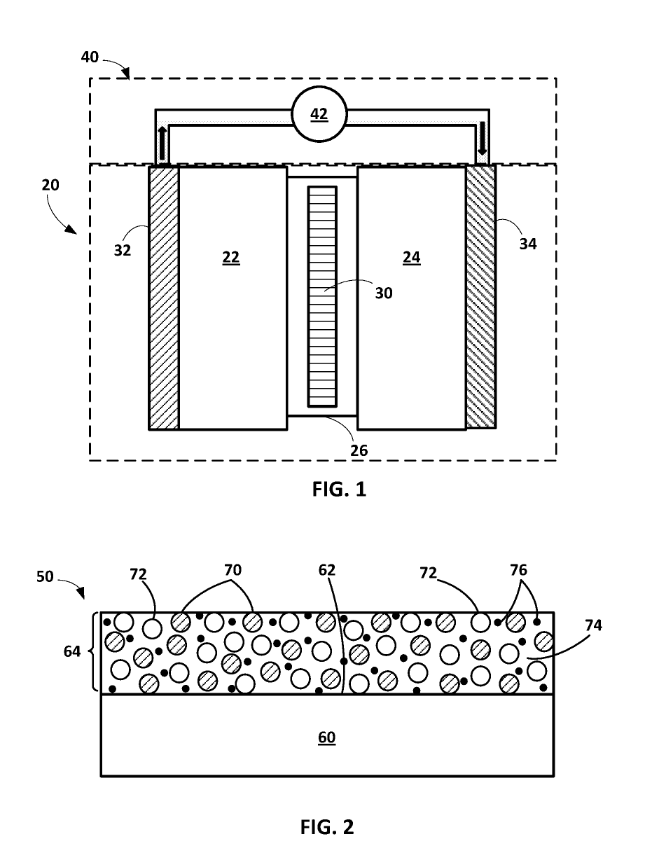

An exemplary schematic illustration of a lithium-ion battery 20 is shown in FIG. 1. Lithium-ion battery 20 includes a negative electrode 22, a positive electrode 24, and a porous separator 26 (e.g., a microporous or nanoporous polymeric separator) disposed between the two electrodes 22, 24. The porous separator 26 includes an electrolyte 30, which may also be present in the negative electrode 22 and positive electrode 24. A negative electrode current collector 32 may be positioned at or near the negative electrode 22 and a positive electrode current collector 34 may be positioned at or near the positive electrode 24. While not shown, the negative electrode current collector and the positive electrode current collector may be coated on one or both sides, as is known in the art. In certain aspects, the current collectors may be coated with an active material/electrode layer on both sides. The negative electrode current collector 32 and positive electrode current collector 34 respectively collect and move free electrons to and from an external circuit 40. An interruptible external circuit 40 and load 42 connects the negative electrode 22 (through its current collector 32) and the positive electrode 24 (through its current collector 34).

The porous separator 26 operates as both an electrical insulator and a mechanical support, by being sandwiched between the negative electrode 22 and the positive electrode 24 to prevent physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the lithium-ion battery 20.

The lithium-ion battery 20 can generate an electric current during discharge by way of reversible electrochemical reactions that occur when the external circuit 40 is closed (to connect the negative electrode 22 and the positive electrode 34) when the negative electrode 22 contains a relatively greater quantity of cyclable lithium. The chemical potential difference between the positive electrode 24 and the negative electrode 22 drives electrons produced by the oxidation of intercalated lithium at the negative electrode 22 through the external circuit 40 toward the positive electrode 24. Lithium ions, which are also produced at the negative electrode, are concurrently transferred through the electrolyte 30 and porous separator 26 towards the positive electrode 24. The electrons flow through the external circuit 40 and the lithium ions migrate across the porous separator 26 in the electrolyte 30 to form intercalated or alloyed lithium at the positive electrode 24. The electric current passing through the external circuit 40 can be harnessed and directed through the load device 42 until the intercalated lithium in the negative electrode 22 is depleted and the capacity of the lithium-ion battery 20 is diminished.

The lithium-ion battery 20 can be charged or re-energized at any time by connecting an external power source (e.g., charging device) to the lithium-ion battery 20 to reverse the electrochemical reactions that occur during battery discharge. The connection of an external power source to the lithium-ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the lithium-ion battery 20 may vary depending on the size, construction, and particular end-use of the lithium-ion battery 20. Some notable and exemplary external power sources include, but are not limited to, AC power sources, such as an AC wall outlet and a motor vehicle alternator. In many lithium-ion battery configurations, each of the negative current collector 32, negative electrode 22, the separator 26, positive electrode 24, and positive current collector 34 are prepared as relatively thin layers (for example, from several microns to a millimeter or less in thickness) and assembled in layers connected in electrical series and/or parallel arrangement to provide a suitable electrical energy and power package.

Furthermore, the lithium-ion battery 20 can include a variety of other components that while not depicted here are nonetheless known to those of skill in the art. For instance, the lithium-ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. As noted above, the size and shape of the lithium-ion battery 20 may vary depending on the particular application for which it is designed. Battery-powered vehicles and hand-held consumer electronic devices, for example, are two examples where the lithium-ion battery 20 would most likely be designed to different size, capacity, and power-output specifications. The lithium-ion battery 20 may also be connected in series or parallel with other similar lithium-ion cells or batteries to produce a greater voltage output, energy, and power if it is required by the load device 42.

Accordingly, the lithium-ion battery 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the lithium-ion battery 20 for purposes of storing energy. In certain other variations, the electrochemical cell may be a supercapacitor, such as a lithium-ion based supercapacitor.

With renewed reference to FIG. 1, any appropriate electrolyte 30, whether in solid form or solution, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20. A non-limiting list of lithium salts that may be dissolved in an organic solvent to form the non-aqueous liquid electrolyte solution include lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium bis-(oxalate)borate (LiB(C₂O₄)₂) (LiBOB); lithium hexafluoroarsenate (LiAsF₆); lithium trifluoromethanesulfonate (LiCF₃SO₃); bis(trifluoromethanesulfonimide) (LiN(CF₃SO₂)₂); lithium fluorosulfonylimide (LiN(FSO₂)₂); and combinations thereof.

These lithium salts may be dissolved in a variety of organic solvents, including but not limited to various alkyl carbonates, such as cyclic carbonates (e.g., ethylene carbonate (EC), propylene carbonate (PC), butylene carbonate(BC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), and combinations thereof.

In other variations, solid electrolytes can be used. This includes solid-polymer electrolyte, as well as solid ceramic-based electrolytes that conduct lithium ions. In certain solid electrolyte designs, no separator or binder may be necessary in the electrochemical cell. In designs with liquid electrolyte, the electrochemical cell includes a separator structure.

The porous separator 26 may include, in instances, a microporous polymeric separator including a polyolefin (including those made from a homopolymer (derived from a single monomer constituent) or a heteropolymer (derived from more than one monomer constituent)), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2320 (a trilayer polypropylene/polyethylene/polypropylene separator) available from Celgard LLC.

When the porous separator 26 is a microporous polymeric separator, it may be a single layer or a multi-layer laminate. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (such as polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF-hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, and/or combinations thereof.

Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

The positive electrode 24 may be formed from a lithium-based active material that can sufficiently undergo lithium intercalation and deintercalation or alloying and dealloying, while functioning as the positive terminal of the lithium-ion battery 20. The positive electrode 24 may include a polymeric binder material to structurally fortify the lithium-based active material. The positive electrode 24 electroactive materials may include one or more transition metals, such as manganese (Mn), nickel (Ni), cobalt (Co), chromium (Cr), iron (Fe), vanadium (V), and combinations thereof.

Two exemplary, non-limiting, common classes of known electroactive materials that can be used to form the positive electrode 24 are lithium transition metal oxides with layered structures and lithium transition metal oxides with a spinel phase. For example, in certain instances, the positive electrode 24 may include a spinel-type transition metal oxide, like lithium manganese oxide (Li₍₁₊ₓ₎Mn₍₂₋ₓ₎O₄), where x is typically less than 0.15, including LiMn₂O₄ (LMO) and lithium manganese nickel oxide LiMn_{1.5}Ni_{0.5}O₄ (LMNO). In other instances, the positive electrode 24 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used.

Such active materials may be intermingled with an optional electrically conductive material (e.g., particles) and at least one polymeric binder, for example, by slurry casting active materials and optional conductive material particles with such binders, like polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, and combinations thereof. Electrically conductive materials may include graphite, other carbon-based materials, conductive metals or conductive polymer particles. Carbon-based materials may include by way of non-limiting example, particles of KETCHEN™ black, DENKA™ black, acetylene black, carbon black, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of electrically conductive materials may be used. The positive current collector 34 may be formed from aluminum or any other appropriate electrically conductive material known to those of skill in the art. As noted above, the positive current collector 34 may be coated on one or more sides.

In various aspects, the negative electrode 22 includes an electroactive material as a lithium host material capable of functioning as a negative terminal of a lithium-ion battery. The negative electrode 22 may thus include the electroactive lithium host material and optionally another electrically conductive material, as well as one or more polymeric binder materials to structurally hold the lithium host material together. For example, in one embodiment, the negative electrode 22 may include an active material including carbon-containing compounds, like graphite, silicon (Si), tin (Sn), or other negative electrode particles intermingled with a binder material selected from the group consisting of: polyvinylidene difluoride (PVdF), ethylene propylene diene monomer (EPDM) rubber, or carboxymethoxyl cellulose (CMC), a nitrile butadiene rubber (NBR), lithium polyacrylate (LiPAA), sodium polyacrylate (NaPAA), sodium alginate, lithium alginate, and combinations thereof, by way of non-limiting example. Suitable additional electrically conductive particles may include a material selected from carbon-based materials, conductive metals, conductive polymers, and combinations thereof. Carbon-based materials may include by way of non-limiting example, particles of KETCHEN™ black, DENKA™ black, acetylene black, carbon black, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of conductive particle materials may be used.

As discussed above, a battery may have a laminated cell structure, comprising an anode or negative electrode layer 22, a cathode or positive electrode layer 24, and electrolyte/separator 26, 30 between the negative electrode 22 and the positive electrode 24 layers. The negative electrode 22 and the positive electrode 24 layers each comprise a current collector (negative current collector 32 and positive current collector 34). A negative anode current collector 32 may be a copper collector foil, which may be in the form of an open mesh grid or a thin film. The current collectors can be connected to an external current collector tab. The negative and positive current collectors 32, 34 may be coated with cathode and anode layers respectively on both sides (double-sided coating).

In various aspects, the present disclosure provides a hybrid negative electrode, which can be used as negative electrode 22. FIG. 2 shows one variation of a hybrid negative electrode 50 that comprises a hybrid electroactive material including a combination of two distinct electroactive materials. The hybrid negative current collector includes a negative current collector 60 that has a first surface 62 on which an electroactive layer 64 is disposed. As discussed above, the negative current collector 60 may be formed from copper or any other appropriate electrically conductive material known to those of skill in the art. Further, the negative current collector 60 may be coated on one or more sides.

The electroactive layer 64 includes a plurality of first electroactive particles 70 that are formed of a high energy capacity electroactive material. The electroactive layer 64 also includes a plurality of second electroactive particles 72 that are formed of a high power capacity electroactive material. Together the plurality of first electroactive particles 70 and second electroactive particles 72 form a hybrid electroactive material, as will be described further below. The electroactive layer 64 also includes a polymeric binder 74 and optionally a plurality of electrically conductive particles 76.

In certain aspects, the hybrid electroactive material in the electroactive layer 64 may include greater than or equal to about 20% by mass to less than or equal to about 80% by mass of the plurality of first electroactive particles 70 formed of high energy capacity electroactive material, optionally greater than or equal to about 40% by mass to less than or equal to about 60% by mass, and optionally greater than or equal to about 45% by mass to less than or equal to about 55% by mass of the plurality of first electroactive particles 70. A high energy capacity electroactive material may have a specific capacity of greater than or equal to about 310 mAh/g, optionally greater than or equal to about 320 mAh/g, optionally greater than or equal to about 330 mAh/g, optionally greater than or equal to about 340 mAh/g, optionally greater than or equal to about 350 mAh/g, optionally greater than or equal to about 360 mAh/g, optionally greater than or equal to about 370 mAh/g, and in certain variations, optionally greater than or equal to about 372 mAh/g. The high energy capacity electroactive material may be selected from the group consisting of: carbon-containing materials, silicon, silicon-containing alloys, tin-containing alloys, and combinations thereof. In certain variations, the high energy capacity electroactive material comprises a carbon-containing compound, such as disordered carbons and graphitic carbons/graphite.

Graphite is a high energy capacity electroactive material often used to form the hybrid negative electrode 50 due to its relatively high energy density (e.g., about approximately 350 mAh/g) and because it is relatively non-reactive in the electrochemical cell environment. Commercial forms of graphite and other graphene materials that may be used to fabricate the plurality of first electroactive particles 70 in the hybrid negative electrode 50 are available from, by way of non-limiting example, Timcal Graphite and Carbon of Bodio, Switzerland, Lonza Group of Basel, Switzerland, or Superior Graphite of Chicago, United States of America. Other materials can also be used to form the plurality of first electroactive particles 70 in the hybrid negative electrode 50, including, for example, lithium-silicon and silicon containing binary and ternary alloys and/or tin-containing alloys, such as Si—Sn, SiSnFe, SiSnAl, SiFeCo, SnO₂, and the like. The present technology is particularly suitable for use with the plurality of first electroactive particles 70 for the negative electrode 50 that includes graphite electroactive materials.

In certain aspects, the hybrid electroactive material in the electroactive layer 64 may include greater than or equal to about 20% by mass to less than or equal to about 80% by mass of the plurality of second electroactive particles 72 formed of high power capacity electroactive material, optionally greater than or equal to about 40% by mass to less than or equal to about 60%, and optionally greater than or equal to about 45% by mass to less than or equal to about 55% by mass of the plurality of second electroactive particles 72. A high power capacity electroactive material may have a potential versus Li/Li+ of greater than or equal to about 1 V during lithium ion insertion optionally a potential versus Li/Li+ of greater than or equal to about 1.5 V during lithium ion insertion. In certain variations, the high power capacity electroactive material may be a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof In certain variations, the high power capacity electroactive material comprises Li₄₊ₓTi₅O₁₂, where 0≤x≤3, including lithium titanate (Li₄Ti₅O₁₂) (LTO). LTO has a lower specific capacity (175 mAh/g) than other negative electroactive materials like graphite, but operates at a higher potential and hence is less susceptible to lithium plating during charging at high voltages/high charge rates.

It should be noted that the plurality of second electroactive particles 72 may have a coating of another material formed thereon, for example, as described in U.S. Pat. No. 9,059,451 to Xiao et al, entitled “Coatings for Lithium Titanate to Suppress Gas Generation in Lithium-Ion Batteries and Methods for Making and Using the Same,” the relevant portions of which are incorporated by reference herein. U.S. Pat. No. 9,059,451 describes applying ultrathin coatings to LTO particles, which may be fluoride-based, carbide-based, or nitride-based to protect LTO from contact and reaction with various species to minimize gas formation in a lithium ion electrochemical cell. However, other materials may likewise be used as protective coatings.

The polymeric binder 74 may be any of those known in the art and may be selected from the group consisting of: polyvinylidene difluoride (PVdF), ethylene propylene diene monomer (EPDM) rubber, or carboxymethoxyl cellulose (CMC), a nitrile butadiene rubber (NBR), lithium polyacrylate (LiPAA), sodium polyacrylate (NaPAA), sodium alginate, lithium alginate, and combinations thereof, by way of non-limiting example. Suitable electrically conductive particles 76 may include a material selected from carbon-based materials, conductive metals, conductive polymers, and combinations thereof, like those mentioned above, including carbon-based materials such as particles of KETCHEN™ black, DENKA™ black, acetylene black, carbon black, and the like. The plurality of electrically conductive particles 76 may include conductive metal particles, such as nickel, gold, silver, copper, aluminum, combinations and alloys thereof, and the like. Examples of a conductive polymer for use as electrically conductive particles 76 include polyaniline, polythiophene, polyacetylene, polypyrrole, and the like. In certain aspects, mixtures of electrically conductive particles 76 materials may be used. The electrically conductive particles 76, the plurality of first electroactive particles 70, and the plurality of second electroactive particles 72 may be mixed and distributed within the polymeric binder 74. In certain aspects, the electrically conductive particles 76, the plurality of first electroactive particles 70, and the plurality of second electroactive particles 72 may be homogeneously mixed and distributed within the binder 74.

The electroactive layer 64 may comprise greater than or equal to about 20 to less than or equal to about 80% by mass of the first electroactive particles 70 (high energy capacity electroactive material), greater than or equal to about 20 to less than or equal to about 80% by mass of the second electroactive particles 72 (high power capacity electroactive material), greater than or equal to about 0 to less than or equal to about 10% by mass of the binder 74, and greater than or equal to about 0 to less than or equal to about 10% by mass of the electrically conductive particles 72. In certain variations, the electroactive layer 64 may comprise greater than or equal to about 40 to less than or equal to about 60% by mass of the first electroactive particles 70 (high energy capacity electroactive material), greater than or equal to about 40 to less than or equal to about 60% by mass of the second electroactive particles 72 (high power capacity electroactive material), greater than or equal to about 0 to less than or equal to about 10% by mass of the binder 74, and greater than or equal to about 0 to less than or equal to about 10% by mass of the electrically conductive particles 72. In yet other variations, the electroactive layer 64 may comprise greater than or equal to about 45 to less than or equal to about 55% by mass of the first electroactive particles 70 (high energy capacity electroactive material), greater than or equal to about 45 to less than or equal to about 55% by mass of the second electroactive particles 72 (high power capacity electroactive material), greater than or equal to about 0 to less than or equal to about 10% by mass of the binder 74, and greater than or equal to about 0 to less than or equal to about 10% by mass of the electrically conductive particles 72.

The hybrid negative electrode 50 may be made by mixing the plurality of first electroactive particles 70 formed of high energy capacity electroactive material (such as graphite particles), a plurality of second electroactive particles 72 that are formed of a high power capacity electroactive material (such as LTO powder or particles) into a slurry with the polymeric binder 74, one or more non-aqueous solvents, optionally one or more plasticizers, and the electrically conductive particles 76. The slurry can be mixed or agitated, and then thinly applied to a substrate via a doctor blade. The substrate can be a removable substrate or alternatively a functional substrate, such as the current collector 60 (such as a metallic grid or mesh layer) attached to one side of an electrode film. In one variation, heat or radiation can be applied to evaporate the solvent(s) from the electrode film, leaving a solid residue. The electrode film may be further consolidated, where heat and pressure are applied to the film to sinter and calendar it. In other variations, the film may be air-dried at moderate temperature to form self-supporting films. If the substrate is removable, then it is removed from the electrode film that may then be further laminated to a current collector. With either type of substrate it may be necessary to extract or remove the remaining plasticizer prior to incorporation into the battery cell. The hybrid negative electrode 50 thus formed may include one or more layers that cumulatively may have a thickness of greater than or equal to about 10 μm to less than or equal to about 300 μm.

In certain variations, an electrode membrane, such as a negative electrode membrane comprises the hybrid electrode active materials (e.g., LTO and graphite) dispersed in a polymeric binder matrix disposed over the negative current collector. The separator can then be positioned over the negative electrode element, which is covered with a positive electrode membrane comprising a composition of a finely divided lithium insertion compound distributed in a polymeric binder matrix. A positive current collector, such as aluminum collector foil or grid completes the assembly. The negative and positive current collectors can be further coated on one or more sides, as discussed above. Tabs of the current collector elements form respective terminals for the battery. A protective bagging material covers the cell and prevents infiltration of air and moisture. Into this bag, an electrolyte is injected into the separator (and may also be imbibed into the positive and/or negative electrodes) suitable for lithium ion transport. In certain aspects, the laminated battery is further hermetically sealed prior to use.

The hybrid negative electrode 50 provided by certain aspects of the present disclosure is similar to a standard negative electrode 22 and therefore can be incorporated into an electrochemical cell without requiring significant design modifications. In this manner, by including both a high energy capacity electroactive material and a high power capacity electroactive material in a single hybrid negative electrode 50, a lithium ion electrochemical cell incorporating such a hybrid negative electrode 50 is capable of charging at a rate of greater than or equal to about 4 C at 25° C., where a 1 C rate would charge the electrode from zero state of charge to 100% state of charge in one hour. In other words, a negative electrode is contemplated that achieves both fast charge capability and high energy density, where high power capacity electroactive material, like LTO, serves as the carrier for fast charging, while high energy capacity electroactive material, like graphite, serves as the carrier for high energy density.

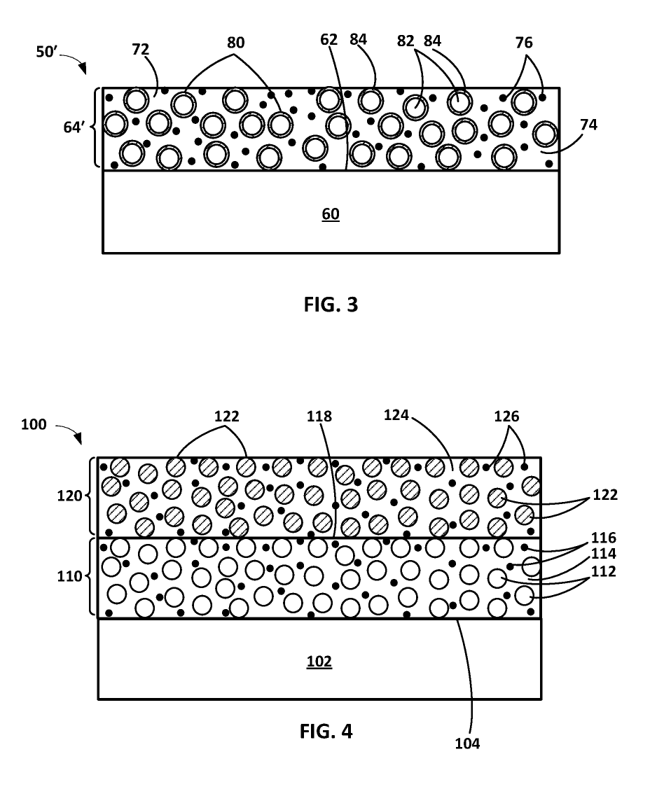

FIG. 3 shows another variation of a hybrid negative electrode 50′ that comprises a hybrid electroactive material including a combination of two distinct electroactive materials. To the extent that the components in the hybrid negative electrode 50′ are the same as those described in the context of FIG. 2 or formation techniques are the same, for brevity they will not be discussed or only briefly discussed herein. An electroactive layer 64′ includes a plurality of electroactive particles 80. Each particle of the plurality of electroactive particles 80 includes both a high energy capacity electroactive material and a high power capacity electroactive material. As shown in FIG. 3, a core 82 of each particle 80 is formed of the high power capacity material, such as LTO, while a coating or shell 84 is formed of a high energy capacity material, such as graphite. The shell 84 may cover greater than or equal to about 90% of the exposed surface area of the core 82, optionally greater than or equal to about 95% of the exposed surface area of the core 82, and in certain variations, optionally greater than or equal to about 99% of the exposed surface area of the core 82, for example. The coating or shell 84 may have a thickness of greater than or equal to about 0.1 nm to less than or equal to about 100 nm. In one example, a thickness of the coating or shell 84 may be a nominal thickness of about 10 nm. The plurality of electroactive particles 80 and electrically conductive particles 76 may be mixed and distributed within the polymeric binder 74. In certain aspects, the plurality of electroactive particles 80 and the electrically conductive particles 76 may be homogeneously mixed and distributed within the binder 74.

The same performance characteristics (e.g., energy density and rate of charging/power density) of the hybrid negative electrode 50 discussed above in the context of FIG. 2 can be achieved by the hybrid negative electrode 50′ described here in the context of FIG. 3. While FIG. 3 shows the high energy capacity electroactive material being disposed as a coating on a surface of a particle of the high power capacity electroactive material, in alternative embodiments not shown in the figures, the high power capacity electroactive material (e.g., LTO) may instead be disposed as a coating on a surface of a particle of the high energy capacity electroactive material (e.g., carbon, including disordered carbons and graphitic carbons).

FIG. 4 shows another variation of a hybrid negative electrode 100 including multiple distinct electroactive material layers. The hybrid negative electrode 100 includes a negative current collector 102, like those described previously. A first electroactive layer 110 is disposed on a surface 104 of the current collector 102, so that the first electroactive layer 110 is in contact with the surface 104. The first electroactive layer 110 comprises a high power capacity electroactive material (as described previously above in the context of FIGS. 2-3), for example, as a plurality of first electroactive particles 112 comprising a high power capacity material, like LTO. The first electroactive layer 110 also includes a first binder 114, which may be any of those described above in the context of FIGS. 2-3. Along with the plurality of first electroactive particles 112, an optional first electrically conductive particle 116 (which may have a composition like those described in the embodiments shown in FIGS. 2-3), may be distributed within the first binder 114. The plurality of first electroactive particles 112 and first electrically conductive particles 116 may be homogeneously mixed and distributed within the first binder 114.

A second electroactive layer 120 is disposed on and in contact with a surface 118 of the first electroactive layer 110. The second electroactive layer 120 comprises a high energy capacity electroactive material (as described previously above in the context of FIGS. 2-3), for example, as a plurality of second electroactive particles 122 comprising a high energy capacity material, like graphite. The second electroactive layer 120 also includes a second binder 124, which again may be any of those described above in the context of the FIGS. 2-3. Along with the plurality of second electroactive particles 122, a plurality of optional second electrically conductive particles 126 (which may have a composition like those described in the embodiments shown in FIGS. 2-3), may be distributed within the second binder 124. The plurality of second electroactive particles 122 and second electrically conductive particles 126 may be homogeneously mixed and distributed within the second binder 124.

The first electroactive layer 110 may have a thickness of greater than or equal to about 10 micrometers (μm) to less than or equal to about 300 micrometers and the second electroactive layer 120 may have a thickness of greater than or equal to about 10 micrometers to less than or equal to about 300 micrometers. The first electroactive layer 110 may comprise greater than or equal to about 80 to less than or equal to about 100% by mass of the first electroactive particles 112 (high power capacity electroactive material), greater than or equal to about 0 to less than or equal to about 10% by mass of the first binder 114, and greater than or equal to about 0 to less than or equal to about 10% by mass of the first electrically conductive particles 116. The second electroactive layer 120 may comprise greater than or equal to about 80 to less than or equal to about 100% by mass of the second electroactive particles 122 (high energy capacity electroactive material), greater than or equal to about 0 to less than or equal to about 10% by mass of the second binder 124, and greater than or equal to about 0 to less than or equal to about 10% by mass of the second electrically conductive particles 126.

Such a multilayered hybrid negative electrode 100 can be made in a similar manner to the slurry casting techniques discussed above in the context of FIG. 1, for example, by sequential slurry casting of the distinct materials for the first electroactive layer 110 and the second electroactive layer 120. Alternatively, the multilayered hybrid negative electrode 100 can be made by co-extruding both the first electroactive layer 110 and the second electroactive layer 120 concurrently from two distinct extrusion heads to form co-extruded layers.

With the multilayered hybrid negative electrode 100, the first electroactive layer 110 comprises the plurality of first electroactive particles 112 with the high power capacity electroactive material has a higher standard electrode potential relative to a Li reference (e.g., LTO in an LTO-graphite hybrid negative electrode). The first electroactive particles 112 with a high power capacity electroactive material (e.g., LTO) are disposed at the back of the electrode structure near (e.g., in contact with) the current collector 102, so that the first electroactive particles 112 react first and give a more uniform reaction distribution. The more resistive second electroactive particles 122 comprising the high energy capacity material (e.g., graphite) will react with lithium ions later than the first electroactive particles 112, but with lower impedance. In this configuration, the multilayered hybrid negative electrode 100 has a reduced resistance/impedance than comparative negative electrodes. However, it should be noted that use of the first electroactive particles 112 with a high power capacity electroactive material (e.g., LTO) disposed at the front of the electrode structure is exemplary and in alternative embodiments, the multilayered electrode may have other configurations.

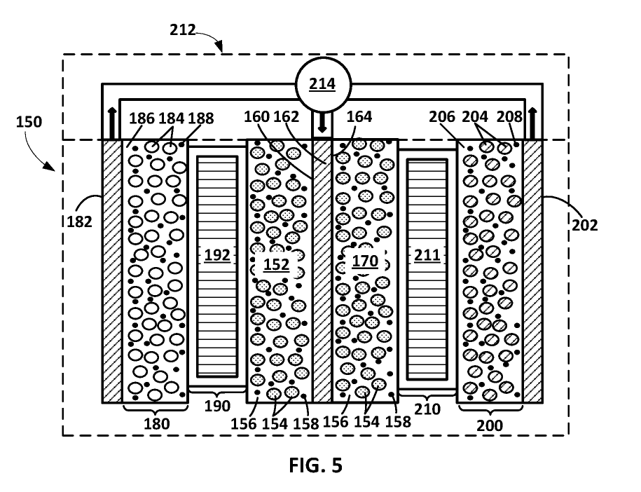

FIG. 5 shows yet another variation of a hybrid negative electrode design. In FIG. 5, a representative electrochemical cell 150 can be incorporated into a lithium-ion electrochemical battery (not shown), by way of example. As will be discussed further below, a stack of distinct cells may be used in a lithium-ion battery and in electrical communication with one another. The cell 150 includes a first positive electrode 152 that comprises a positive electroactive material 154. The first positive electrode 152 may also include a binder resin 156 and electrically conductive particles 158, such as any of those described above in the context of FIG. 1. The first positive electrode 152 is disposed on a first surface 160 of a positive current collector 162. The cell 150 includes a second positive electrode 170 disposed on a second surface 164 of the positive current collector 162. The second positive electrode 170 may have the same or different composition from the first positive electrode 152. As shown in FIG. 5, the second positive electrode 170 has the same composition and includes the positive electroactive material 154, binder resin 156, and electrically conductive particles 158.

The cell 150 also includes a first negative electrode 180 disposed on a first negative current collector 182. The first negative electrode 180 comprises a plurality of first negative electroactive particles 184 formed of a high power capacity electroactive material, as discussed previously above, such as LTO. The first negative electrode may also include a first binder 186 and a first electrically conductive particle 188. The plurality of first negative electroactive particles 184 (formed of the high power capacity electroactive material) and the first electrically conductive particles 188 are distributed in the first binder 186. A first separator 190 that may be imbued with electrolyte 192 is disposed between the first positive electrode 152 and the first negative electrode 180.

A second negative electrode 200 disposed on a second negative current collector 202. The second negative electrode 200 comprises a plurality of second negative electroactive particles 204 formed of a high energy capacity electroactive material, as discussed previously above, such as graphite. The second negative electrode 200 may also include a second binder 206 and a plurality of second electrically conductive particles 208. The plurality of second negative electroactive particles 204 (formed of the high energy capacity electroactive material) and the second electrically conductive particles 208 are distributed in the second binder 206. A second separator 210 that may be imbued with electrolyte 211 is disposed between the second positive electrode 170 and the second negative electrode 200. The positive current collector 162 is in electrical communication with the first positive electrode 152 and/or the second positive electrode 170. The first negative electrode current collector 182, the second negative electrode current collector 202, and the positive electrode current collector 162 respectively collect and move free electrons to and from an interruptible external circuit 212. The external circuit 212 and load 214 connects the first negative electrode 180 (through its first negative current collector 182), the second negative electrode 200 (through its second negative current collector 202), and the first and second positive electrodes, 152, 172 (through shared positive current collector 162).

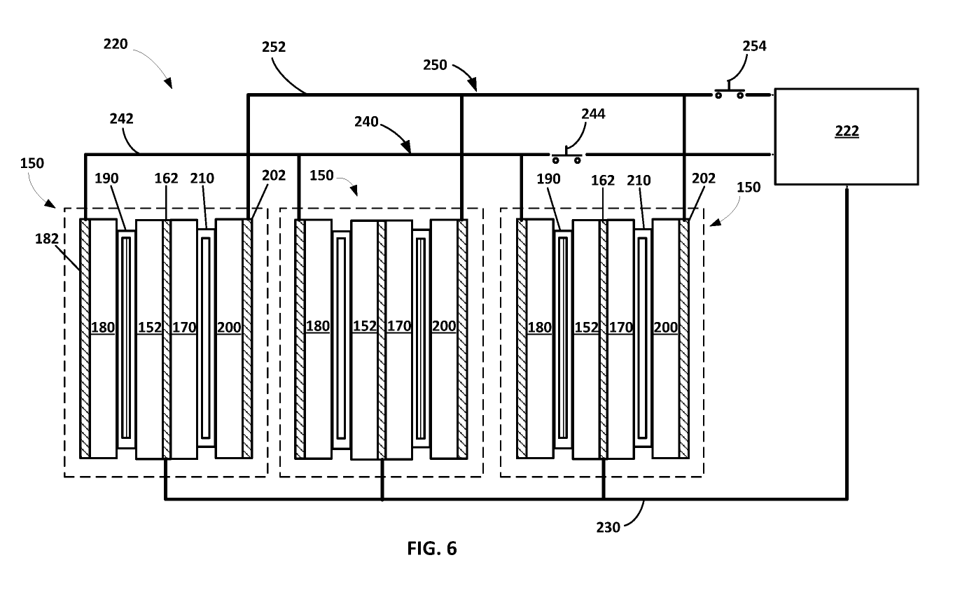

FIG. 6 shows a stack 220 as an energy storage device having a plurality of representative electrochemical cells 150 like that described in detail in FIG. 5 (shown in a simplified version) connected to an external charging device and therefore in a charging state. As described in the context of FIG. 5, each cell 150 includes a first positive electrode 152, at least one positive current collector 162, a second positive electrode 170, a first negative electrode 180 comprising a high power capacity negative electroactive material, like LTO, disposed on a first negative current collector 182, and a second negative electrode 200 comprising a high energy capacity negative electroactive material, like graphite, disposed on a second negative current collector 202. A first separator 190 is disposed between the first negative electrode 180 and first positive electrode 152, while second separator 210 is disposed between the second negative electrode 200 and second positive electrode 170. The first separator 190 and the second separator 210 can be made of the same or different materials.

A source of electrical energy in the form of a charging device 222 is in electrical communication with each respective cell 150 in the stack 220. The charging device 222 may provide AC current and may be, for example, any of an AC charging station, an AC wall outlet, or an alternator, by way of non-limiting example. The charging device 222 may be in electrical communication with a first conduit 230 that connects each of the positive current collectors 162 in each respective cell 150, for example, shown connected in parallel. A first circuit 240 is interruptible and formed by a second conduit 242 that is in electrical communication with the charging device 222 and further connected to each first negative current collector 182 associated with the first negative electrodes 180 having the high power capacity electroactive materials in each respective cell 150. As noted above, the charging device 222 is in electrical communication with the first conduit 230 so as to complete and form the circuit. The first circuit 240 includes a first switch component 244 in the second conduit 242 that can be engaged and disengaged by associated external control equipment. The first switch component 244 may be a relay type switch, by way of non-limiting example.

A second circuit 250 is interruptible and formed by a third conduit 252 that is also in electrical communication with the charging device 222 and further connected to each second negative current collector 202 associated with the second negative electrodes 200 having the high energy capacity electroactive materials in each respective cell 150. As noted above, the charging device 222 is in electrical communication with the first conduit 230, which when connected through the charging device 222 and the third conduit 252, forms the second circuit 250. The second circuit 250 includes a second switch component 254 in the third conduit 252 that can be engaged and disengaged by associated external control equipment. The second switch component 254 may be a relay type switch, by way of non-limiting example. By this configuration, the charging device 222 can selectively charge the first negative electrodes 180 in each cell 150, the second negative electrodes 200, or both the first negative electrodes 180 and the second negative electrodes 200 by selective engagement of the first switch component 244 and/or the second switch component 254. Capacitors and other circuit elements can be used in the stack 220 or overall system to avoid unwanted current transients upon operating the switches.

By way of example, in a first high power/high charge rate mode during charging with a high power (“Level 3 capable”) charge device 222 (e.g., a 200 kW, 500 A charger), the first switch component 244 can be closed (e.g., by the switch contactor) so that the first circuit 240 is active and charging, while the second switch component 254 may be open and the second circuit 250 may be inactive. In this manner, the first negative electrodes 180 having the high power capacity negative electroactive material with an opposing cathode (e.g., first positive electrode 152) can be charged along to a preset voltage limit (V_{L1}).

In another charge mode, when a signal to the charge device 222 is turned to off (zero current), the first switch component 244 can be opened (so that the first circuit 240 is inactive), while the second switch component 254 may be closed and the second circuit 250 may be actively charging. The signal to the charge device 222 permits it to deliver appropriately lower current (“Level 2”, e.g., 6.6 kW, 20 A) to a preset voltage limit (V_{L1}).

In yet another charge mode, when a signal to the charge device 222 is turned to off (zero current), the first switch component 244 can be closed (so that the first circuit 240 is active) and actively charging, while the second switch component 254 is also closed and the second circuit 250 is also actively charging. The signal to the charge device 222 permits it to deliver appropriately lower current (“Level 2”, e.g., 6.6 kW, 20 A) to a second, higher preset voltage limit (V_{L2}). The potential can be held at V_{L2} until current drops below a preset threshold I₁ (a so called taper charge). Then, the first switch component 244 and the second switch component 254 can both be opened and charging is complete.

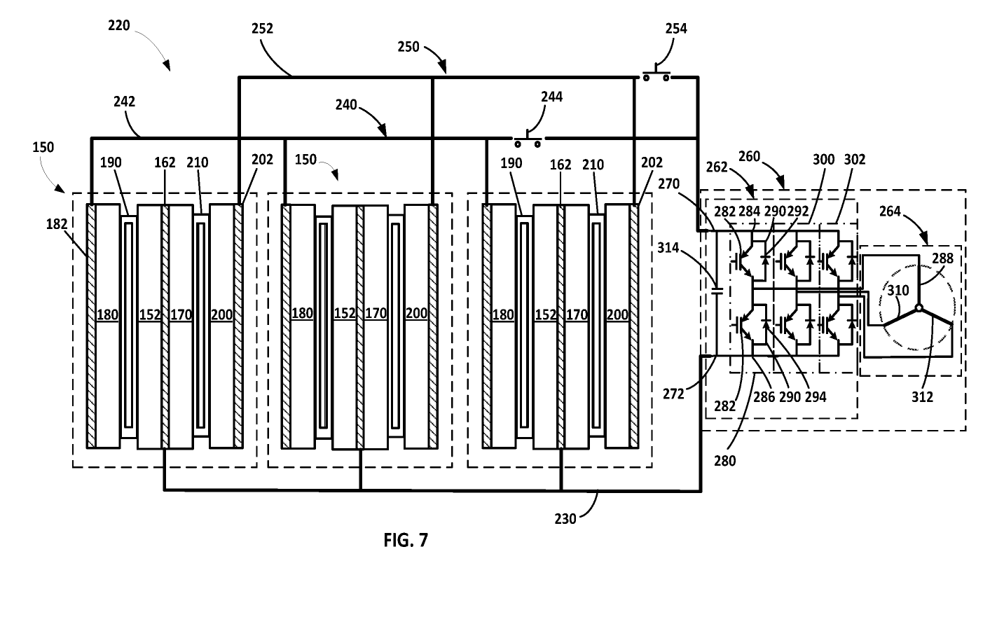

FIG. 7 shows the stack 220 having a plurality of representative electrochemical cells 150 described in detail in the context of FIG. 6, but connected to a load device 260, such as an electric motor of a vehicle and therefore in a discharging state. For brevity, to the extent that the various components function in the same way, they will not be reintroduced or discussed herein. The load device 260 as shown is merely exemplary, but in this design, includes an inverter power module 262 that may be connected to an electric motor 264. The electric motor 264 that may be a permanent magnet (PM) electric motor or another suitable type of electric motor that outputs voltage based on back electromagnetic force (EMF) when free spinning, such as a direct current (DC) electric motor or a synchronous electric motor.

High (positive) and low (negative) sides 270 and 272 are connected to positive and negative terminals, respectively, of the first circuit 240 and/or the second circuit 250. The inverter power module 262 is also connected between the high and low sides 270 and 272. In the example of the electric motor 264 being a three-phase PM electric motor, the inverter power module 262 may include three legs, one leg connected to each phase of the electric motor 264. Generally, as described further below, the inverter power module 262 is a three-phase power inverter with drive gates and a capacitive input filter.

More specifically, a first leg 280 includes a first pair of switches 282, which may each include a first terminal, a second terminal, and a control terminal. A first switch 284 of the first pair of switches 282 may be connected to the high side 270, while the other, a second switch 286 of the first pair of switches 282 may be connected to the low side 272. Each of the first pair of switches 282 may be an insulated gate bipolar transistor (IGBT), a field effect transistor (FET), such as a metal oxide semiconductor FET (MOSFET), or another suitable type of switch. In the example of IGBTs and FETs, the control terminal is referred to as a gate. Within the first pair of switches 280, a first terminal of the first switch 284 is connected to the high side 270. The second terminal of the first switch 284 is connected to the first terminal of the second switch 286. The second terminal of the second switch 286 may be connected to the low side 272. A node connected to the second terminal of the first switch 284 and the first terminal of the second switch 286 may be connected to a first phase 288 of the electric motor 264.

A power control module (not shown) may control switching of the first pair of switches 280 using pulse width modulation (PWM) signals. For example, the power control module may apply PWM signals to the control terminals of the first switch 284 and the second switch 286. When on, power flows from the stack of cells 150 to the electric motor 264 to drive the electric motor 264.

The first leg 280 also includes a first pair of diodes 290, including a first diode 292 and a second diode 294 connected anti-parallel to the first switch 284 and the second switch 286, respectively. In other words, an anode of the first diode 292 is connected to the second terminal of the first switch 284, and a cathode of the first diode 292 is connected to the first terminal of the first switch 284. An anode of the second diode 294 is connected to the second terminal of the second switch 286, and a cathode of the second diode 394 is connected to the first terminal of the second switch 286. When the first switch 284 and the second switch 286 are off (and open), power generated by the electric motor 264 is transferred through the first pair of diodes 290 when the output voltage of the electric motor 264 is greater than the voltage of the stack 220 of electrochemical cells 150. This charges the stack 220 of electrochemical cells 150. The first pair of diodes 390 forms one phase of a three-phase rectifier.

The inverter power module 262 also includes a second leg 300 and a third leg 302. The second and third legs 300 and 302 may be (circuitry wise) similar or identical to the first leg 280. In other words, the second leg 300 and third leg 302 may each include respective components for the pairs of switches 282 and the diodes 290, connected in the same manner as the first leg 280. The second leg 300 may be electrically connected to a second phase 310 of the electric motor 264. The third leg 302 may be electrically connected to a third phase 312 of the electric motor 264. A capacitive input filter 314 connects the high side 270 and low side 272 to regulate/modulate current flowing within the inverter power module 262.

The PWM signals provided to the switches of the second and third legs 300, 302 may also be generally complementary per leg. The PWM signals provided to the second and third legs 300 and 302 may be phase shifted from each other and from the PWM signals provided to the switches 282 of the first leg 280. For example, the PWM signals for each leg may be phase shifted from each other by 120° (360°/3).

During discharge, it may be desirable to first discharge the first negative electrode 180 comprising a high power capacity negative electroactive material, like LTO as compared to discharging the second negative electrode 200 comprising a high energy capacity negative electroactive material, like graphite, for two reasons. First, the first negative electrode 180 comprising a high power capacity negative electroactive material, can be charged rapidly, so initially depleting the first negative electrodes 180 of lithium (Li ions) makes room for a subsequent fast charge, if necessary. Second, the first negative electrodes 180 comprising a high power capacity negative electroactive material have a much higher cycle life, so such electrodes can be used more often than the second negative electrode 200 over the vehicle life.

Thus, in a first discharge (e.g., driving) mode, just before driving, but after charging, the first switch component 244 can be closed (e.g., by the switch contactor) so that the first circuit 240 connected to the first negative electrodes 180 is active and discharging, while the second switch component 254 may be open and the second circuit 250 connected to the second negative electrodes 200 may be inactive. In this manner, the first negative electrodes 180 and corresponding positive electrode 152 in each cell 150 of the stack are discharged to a preset lower voltage limit V_{L10}.

In a second discharge mode, the first switch component 244 can be open (e.g., by the switch contactor) so that the first circuit 240 connected to the first negative electrodes 180 is inactive, while the second switch component 254 may be closed and the second circuit 250 connected to the second negative electrodes 200 may be active and discharging. Thus, the second negative electrodes 200, for example, those that comprise graphite or other high energy electroactive materials, and the second positive electrodes 170 are discharged to a preset voltage limit V_{L10}.

In yet another discharge mode, the first switch component 244 can be closed so that the first circuit 240 connected to the first negative electrodes 180 is active, while the second switch component 254 may likewise be closed and the second circuit 250 connected to the second negative electrodes 200 may be active and discharging. In this manner, both the first negative electrodes 180/first positive electrodes 152 and the second negative electrodes 200/second positive electrodes 170 are concurrently discharging. This may be characterized as entering a slow discharge mode (e.g., “turtle mode”) to allow low-current (compromised) vehicle discharge operation until lowermost preset voltage limit V_{L20} is obtained (e.g., at end of drive event).

In various aspects, by having two distinct negative electrodes with distinct electroactive materials, including high charge capacity and high power capacity materials, incorporated into a single battery, selective charging of either the high charge capacity material (e.g., graphite) electrode or the high power capacity material (e.g., LTO) electrode can enable both demands on fast charging or high energy density, particularly desirable in vehicle applications.

In various aspects, it is desirable that a lithium-ion electrochemical cell incorporating a hybrid negative electrode according to the various embodiments of the present disclosure may provide a balanced high-energy density/fast charge capability system. For example, such a lithium-ion electrochemical cell with the hybrid negative electrode may be capable of being rapidly charged within about 15 minutes or less to provide for at least about 50 miles of driving range, while slower charging rates over longer durations, for example, three or more hours, can provide a battery with at least 150 miles of driving range.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hybrid negative electrode having high energy capacity and high power capacity, the hybrid negative electrode comprising:
a hybrid electroactive material comprising greater than or equal to about 40% by mass to less than or equal to about 60% by mass of a high energy capacity electroactive material having a specific capacity of greater than or equal to about 310 mAh/g; and
greater than or equal to about 40% by mass to less than or equal to about 60% by mass of a high power capacity electroactive material having a potential versus Li/Li+ of greater than or equal to about 1 V during lithium ion insertion, wherein the hybrid negative electrode is capable of a charge rate of greater than or equal to about 4 C at 25° C.

2. The hybrid negative electrode of claim 1, wherein the high energy capacity electroactive material is selected from the group consisting of: carbon-containing compounds, graphite, silicon, silicon-containing alloys, tin-containing alloys, and combinations thereof.

3. The hybrid negative electrode of claim 1, wherein the high power capacity electroactive material is a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof.

4. The hybrid negative electrode of claim 1, wherein the high energy capacity electroactive material comprises graphite and the high power capacity electroactive material comprises Li₄₊ₓTi₅O₁₂, where 0≤x≤3.

5. The hybrid negative electrode of claim 1, wherein the high energy capacity electroactive material is disposed as a coating on a surface of a particle of the high power capacity electroactive material.

6. The hybrid negative electrode of claim 1, wherein the high power capacity electroactive material is disposed as a coating on a surface of a particle of the high energy capacity electroactive material.

7. The hybrid negative electrode of claim 1, further comprising:
a binder; and
an electrically conductive particle, wherein the hybrid electroactive material and electrically conductive particle are distributed within the binder, and the binder is selected from the group consisting of: polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, and combinations thereof; and
the electrically conductive particle comprises a material selected from the group consisting of: carbon black, conductive metal, conductive polymer, and combinations thereof.

8. A hybrid negative electrode comprising:
a current collector;
a first layer disposed on the current collector comprising a high power capacity electroactive material having a specific capacity of greater than or equal to about 310 mAh/g, a first binder, and a first electrically conductive particle, wherein the high power capacity electroactive material and the first electrically conductive particle are distributed in the first binder; and
a second layer disposed on the first layer comprising a high energy capacity electroactive material having a potential versus Li/Li+ of greater than or equal to about 1 V during lithium ion insertion, a second binder, and a second electrically conductive particle, wherein the high energy capacity electroactive material and the second electrically conductive particle are distributed in the second binder; wherein the hybrid negative electrode is capable of a charge rate of greater than or equal to about 4 C at 25° C.

9. The hybrid negative electrode of claim 8, wherein the high energy capacity electroactive material is selected from the group consisting of: carbon-containing compounds, graphite, silicon, silicon-containing alloys, tin-containing alloys, and combinations thereof and the high power capacity electroactive material is a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof.

10. The hybrid negative electrode of claim 8, wherein the high energy capacity electroactive material comprises graphite and the high power capacity electroactive material comprises Li₄₊ₓTi₅O₁₂, where 0≤x≤3.

11. The hybrid negative electrode of claim 8, wherein the first layer has a thickness of greater than or equal to about 10 micrometers to less than or equal to about 300 micrometers and the second layer has a thickness of greater than or equal to about 10 micrometers to less than or equal to about 300 micrometers.

12. The hybrid negative electrode of claim 8, wherein the first layer comprises greater than or equal to about 80 to less than or equal to about 100% by mass of the high power capacity electroactive material, greater than or equal to about 0 to less than or equal to about 10% by mass of the first binder, and greater than or equal to about 0 to less than or equal to about 10% by mass of the first electrically conductive particle, and
the second layer comprises greater than or equal to about 80 to less than or equal to about 100% by mass of the high energy capacity electroactive material, greater than or equal to about 0 to less than or equal to about 10% by mass of the second binder, and greater than or equal to about 0 to less than or equal to about 10% by mass of the second electrically conductive particle.

13. The hybrid negative electrode of claim 8, wherein the first binder and the second binder are independently selected from the group consisting of: polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, and combinations thereof; and the first electrically conductive particle and the second electrically conductive particle independently comprise a material selected from the group consisting of: carbon black, conductive metal, conductive polymer, and combinations thereof.

14. An electrochemical cell for a lithium-ion electrochemical battery comprising:
a first positive electrode comprising a positive electroactive material;
a first negative electrode comprising a first negative current collector comprising a high power capacity electroactive material having a potential versus Li/Li+ of greater than or equal to about 1.5 V during lithium ion insertion;
a first separator disposed between the first positive electrode and the first negative electrode;
a second positive electrode comprising a positive electroactive material;
a second negative electrode comprising a second negative current collector comprising a high energy capacity electroactive material having a specific capacity of greater than or equal to about 310 mAh/g;
a second separator disposed between the second positive electrode and the second negative electrode; and
at least one positive current collector in electrical communication with the first positive electrode, the second positive electrode, or both the first positive electrode and the second positive electrode; wherein the first negative current collector is in electrical communication with the at least one positive current collector via a first circuit having a first switch component and the second negative current collector is in electrical communication with the at least one positive current collector via a second circuit having a second switch component, wherein the first circuit and the second circuit are configured to be selectively connected to a charging device or a load device and the first negative electrode, the second negative electrode, or both the first negative electrode and the second negative electrode can be selectively activated by activation of the first switch component and/or the second switch component.

15. The electrochemical cell of claim 14, wherein the charging device comprises an AC power source and the load device comprises an electric motor.

16. The electrochemical cell of claim 15, wherein the load device further comprises a three-phase power inverter power module with drive gates and a capacitive input filter.

17. The electrochemical cell of claim 14, wherein the high power capacity electroactive material in the first negative electrode is a lithium titanate compound selected from the group consisting of: Li₄₊ₓTi₅O₁₂, where 0≤x≤3, Li₄₋ₓ^{a}_{/3}Ti₅₋₂ₓ^{a}_{/3}Crₓ^{a}O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof.

18. The electrochemical cell of claim 14, wherein the high energy capacity electroactive material in the second negative electrode is selected from the group consisting of: carbon-containing compounds, graphite, silicon, silicon-containing alloys, tin-containing alloys, and combinations thereof

19. The electrochemical cell of claim 14, wherein the high power capacity electroactive material in the first negative electrode comprises Li₄₊ₓTi₅O₁₂, where 0≤x≤3 and the high energy capacity electroactive material in the second negative electrode comprises graphite.
